(19) United States
(12) Patent Application Publication
(10) Pub. No.: US 2023/0056363 A1
(43) Pub. Date: Feb. 23, 2023

(54) CONTACT ELEMENT ASSEMBLY FOR A PLUG CONNECTOR PART

(71) Applicant: PHOENIX CONTACT E-Mobility GmbH, Schieder-Schwalenberg (DE)

(72) Inventor: Thomas Fuehrer, Blomberg (DE)

(21) Appl. No.: 17/792,718

(22) PCT Filed: Dec. 15, 2020
(86) PCT No.: PCT/EP2020/086095

§ 371 Date: Jul. 14, 2022

(30) Foreign Application Priority Data
Jan. 16, 2020 (DE) 10 2020 100 900.3

(51) Int. Cl. H01R 13/18; H01R 13/11; H01R 13/64; H01R 13/66

(52) U.S. Cl. CPC H01R 13/18; H01R 13/111; H01R 13/64; H01R 13/6683; H01R 2201/26

(57) ABSTRACT

A contact element assembly for a plug connector part connectable to a mating plug connector part includes: a contact element that has a body and a plurality of contact lamellae that are elastically movable at the contact body and that together form a plug opening and can be brought into contact with a mating contact element of the mating plug connector part that is pluggable into the plug opening in an electrically contacting manner; and a sensor device that has a sensor element that is arranged in relation to the contact lamellae such that in an operational state of the contact lamellae the sensor element is not in electrical contact with the contact lamellae, but that come into electrical contact with the at least one of the contact lamellae upon an exceptional deformation on at least one of the contact lamellae. The sensor element is connected to an evaluation device.

### CROSS-REFERENCE TO PRIOR APPLICATIONS

This application is a U.S. National Phase application under 35 U.S.C. § 371 of International Application No. PCT/EP2020/086095, filed on Dec. 15, 2020, and claims benefit to German Patent Application No. DE 10 2020 100 900.3, filed on Jan. 16, 2020. The International Application was published in German on Jul. 22, 2021 as WO/2021/144100 under PCT Article 21(2).

### FIELD

The invention relates to a contact element assembly for a plug connector part.

### BACKGROUND

Such a contact element assembly can be used on a plug connector part that can be plugged into an associated mating plug connector part. Such a contact element assembly has a contact element that comprises a contact body and a plurality of contact lamellae that are elastically movable at the contact body. The contact lamellae together form a plug opening and can be brought into electrical contact with a mating contact element of the mating plug connector part that can be plugged into the plug opening.

Such a contact element can take the form of a contact socket, into which a mating contact element in the form of a contact pin can be plugged. The contact socket forms a plug opening for receiving the mating contact element, wherein the contact lamellae of the contact element are (slightly) elastically deflected during insertion, and thus bear against the mating contact element with elastic contact force, so that a low-resistance electrical transition between the contact element and the mating contact element is created.

A plug connector part of the type in question can be used, for example, as a charging plug or a charging socket for charging an electrically driven vehicle (also referred to as an electric vehicle). A charging socket is arranged, for example, on a vehicle and can be plugged into an associated mating plug connector part in the form of a charging plug on a cable connected to a charging station, in order to establish an electrical connection between the charging station and the vehicle in this way.

Charging currents can be transmitted as direct currents or as alternating currents, wherein in particular charging currents in the form of direct current have a high current intensity, for example 500 A or even more, and can lead to heating of the cable as well as a plug connector part connected to the cable.

In a charging system for charging an electric vehicle, heat is generated not only at the cable with which a charging plug is connected, for example, to a charging station, but also at the charging plug and at the charging socket into which the charging plug is plugged. Thereby, heat arises in particular at contact elements of a charging socket or of a charging plug, via which an electrical contact is established when the charging plug is plugged into the charging socket. Such contact elements, which are made of an electrically conductive metal material, for example made of a copper material, heat up when a charging current flows via the contact elements, wherein in principle the contact elements are to be dimensioned as a function of the charging current to be transmitted such that the contact elements have sufficient current-carrying capacity and the heating at the contact elements is limited. In this case, the higher the charging current to be transmitted, the larger a contact element must be dimensioned.

Heat generation at a contact element is determined in particular by a transfer resistance at which the contact element is in contact with an associated mating contact element. If wear or damage occurs on a contact element, the transfer resistance can be increased, which during operation is accompanied by an increase in power loss and with the heating at the contact element.

With a measuring device known from DE 20 2004 007 830 U1, a measuring tip can be inserted into a plug opening of a socket contact, in order to measure normal forces of the socket contact.

### SUMMARY

In an embodiment, the present invention provides a contact element assembly for a plug connector part connectable to a mating plug connector part, comprising: a contact element that has a body and a plurality of contact lamellae that are elastically movable at the contact body and that together form a plug opening and are configured to be brought into contact with a mating contact element of the mating plug connector part that is pluggable into the plug opening in an electrically contacting manner; and a sensor device that has a sensor element that is arranged in relation to the contact lamellae such that in an operational state of the contact lamellae the sensor element is not in electrical contact with the contact lamellae, but is configured to come into electrical contact with the at least one of the contact lamellae upon an exceptional deformation on at least one of the contact lamellae, wherein the sensor element is connected to an evaluation device configured to evaluate a sensor signal obtained depending on a contact of the at least one contact lamellae with the sensor element.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 a view of a charging system for charging an electric vehicle;

FIG. 2 a view of a plug connector part in the form of a charging plug;

FIG. 3 a view of an exemplary embodiment of a contact element in the form of a contact socket;

FIG. 4 a view of the contact element with a plugged-in mating contact element;

FIG. 5 an exploded view of the contact element together with a sensor device;

FIG. 6 a view of the contact element with a sensor device arranged thereon for detecting an exceptional deformation on one or more contact lamellae of the contact element;

FIG. 7 an enlarged partial view of the arrangement according to FIG. 6;

FIG. 8 a longitudinal sectional view through the contact element with the sensor device arranged thereon;

FIG. 9A the longitudinal sectional view according to FIG. 8, with a mating contact element plugged into the contact element;

FIG. 9B an enlarged view of detail A according to FIG. 9A;

FIG. 10A the longitudinal sectional view of the contact element, with an incorrectly plugged-in mating contact element; and

FIG. 10B an enlarged view of detail B according to FIG. 10A.

### DETAILED DESCRIPTION

In an embodiment, the present invention provides a contact element assembly that makes it possible in a simple manner to monitor whether wear or damage has possibly occurred on a contact element of the contact element assembly.

Accordingly, the contact element assembly comprises a sensor device that comprises a sensor element that is arranged in such a way in relation to the contact lamellae of the contact element that, in an operational state of the contact lamellae, the sensor element is not in electrical contact with the contact lamellae, but is designed to come into electrical contact with the at least one of the contact lamellae in the event of an exceptional deformation on at least one of the contact lamellae, wherein the sensor element is connected to an evaluation device for evaluating a sensor signal obtained in dependence on the contact of the at least one of the contact lamellae with the sensor element.

The sensor device serves to detect an exceptional deformation on one or more of the contact lamellae of the contact element, in order to generate a sensor signal depending on such an exceptional deformation, which sensor signal can be evaluated in order to infer damage or wear on the contact element. If there is an exceptional deformation on one or more of the contact lamellae, for example because one or more contact lamellae are bent (buckled), it can be assumed that contact resistance is increased in the electrical connection of the contact element with the associated mating contact element due to an electrical contact no longer being made available via all contact lamellae or a contact force with which contact lamellae are pressed against the associated mating contact element being reduced. If such an exceptional deformation is determined via the sensor device, a countermeasure can thus be initiated, in order to prevent overheating at the contact element, for example by reducing a transmitted current or by interrupting a transmission process.

The contact lamellae are arranged so as to be elastically movable at the contact body of the contact element. With a conventional plugging process, with which a mating contact element is plugged into the plug opening of the contact element designed as a contact socket, the contact lamellae are deflected slightly elastically at the contact body, so that the contact lamellae rest against the mating contact element with elastic contact force when the mating contact element is plugged into the plug opening. Within the framework of such an operational state, the contact lamellae are not in electrical contact with the sensor element, so that the sensor element is electrically separated from the contact lamellae.

In this connection, the operational state is understood to mean a usual deflection of the contact lamellae during a usual plugging process for contacting with the mating contact element taking the form of a contact pin. Within the framework of such an operational state, when the mating contact element is being plugged into the plug opening of the contact element, the contact lamellae are only slightly deflected and bear against the mating contact element with elastic clamping force, but do not contact the sensor element of the sensor device.

The operational state can be defined, for example, by the clear width of the plug opening not being increased beyond a specific, defined dimension, and the contact lamellae thus being arranged within an (imaginary) circumferential envelope circle surrounding the contact lamellae and not leaving the envelope circle when plugged into the mating contact element.

If an exceptional deformation occurs on one or more of the contact lamellae, for example due to an incorrect insertion of the mating contact element as a result of a break at one or more of the contact lamellae or as a result of an elastic irreversible deformation, for example, in the form of a buckling, the one or more contact lamellae will come into contact with the sensor element. The sensor element thus reaches the potential of the contact element, which can be detected and evaluated via the evaluation device connected to the sensor element. In the case of a change in potential at the sensor element, a corresponding sensor signal can be generated, which indicates that there is a contact between one or more contact lamellae and the sensor element and thus one or more of the contact lamellae have been deflected in an impermissible manner.

Such an exceptional deformation can be temporary or permanent. Both should be displayed by the evaluation device because even a temporary exceptional deformation can increase a contact resistance and thus be evaluated and displayed.

In one development, the sensor element is arranged outside the plug opening. When a mating contact element is being plugged into the plug opening of the contact element, the contact lamellae are adjusted (slightly) radially outwards, wherein, in the event of an exceptional deformation, the contact lamellae pass through the contact element, for example, through an envelope circle around the contact element and defined by the inner circumference of the sensor element, and thereby come into contact with the sensor element arranged outside the plug opening.

The sensor element can have, for example, a cylindrical element body. The element body can, for example, take the form of a sleeve that circumferentially surrounds the contact element in the region of the contact lamellae and, for example, is circumferentially closed. Alternatively, the element body can even be open at one circumferential point and thus take the form of an open ring, for example.

The sensor element can be designed as a rigid element. In the case of deformation of one or more of the contact lamellae, a contact is, for example, established between the contact lamellae and the element body, so that the sensor element reaches the potential of the contact element, which can be evaluated accordingly by the evaluation device.

In one development, the sensor element comprises at least one test finger arranged on the element body. The test finger can, for example, be designed to come into electrical contact with the at least one of the contact lamellae in the event of an exceptional deformation on at least one of the contact lamellae. An electrical contact the event of a deformation on one or more contact lamellae is thus produced by means of a test finger projecting from the element body, wherein the test finger is formed and arranged at the contact lamellae in such a way that, in the event of an exceptional deformation on one or more of the contact lamellae, a contact is produced between the contact lamella or the contact lamellae and the sensor element thus reaches the potential of the contact element.

The at least one test finger can extend, for example, axially from the element body in the direction of tips of the contact lamellae, which lie away from the contact body. One or more test fingers thus project axially from the element body and are arranged in such a way in relation to the contact lamellae that an exceptional deformation at the contact lamellae can be detected.

The test fingers can, for example, be elastically movable at the element body. The elasticity of the test fingers at the element body can, for example, be dimensioned such that the test fingers can be moved (significantly) more softly at the element body than the contact lamellae at the contact body. The background to this is that the test fingers are not intended to influence a contact force provided by the contact lamellae and in particular do not represent a counter-bearing for the contact lamellae. The sensor element with the test fingers arranged thereon is intended to serve for detecting a deformation on the contact lamellae, but not for supporting the contact lamellae in the event of a deformation.

The contact lamellae can be formed in one piece with the contact body of the contact element. For example, the contact element is manufactured as a turned part, with contact lamellae formed in one piece with and integrally with the contact body.

The sensor element can be formed in one piece. In particular, the element body and the test fingers arranged thereon can be formed in one piece and integrally.

A plurality of test fingers can in this case be juxtaposed along a circumferential direction and, for example, separated from one another by slots.

In one development, the contact element assembly has an insulating element that is arranged on the contact body. In this case, the sensor element is arranged on the insulating element and is electrically insulated from the contact element via the insulating element. The insulating element serves for the electrical separation of the sensor element from the contact element, so that in the operational state of the contact lamellae the sensor element is not electrically connected to the contact element and is in particular not at the potential of the contact element. Only in the case of an exceptional deformation at one or more contact lamellae is there a contact with the sensor element, which can be evaluated accordingly by the evaluation device connected to the sensor element.

While the contact element and the sensor element are in each case manufactured from an electrically conductive material, in particular a metal material, for example a copper material, the insulating element is made of an electrically insulating material, for example a plastic material or a ceramic material.

The insulating element has, for example, a ring section surrounding the contact element circumferentially. The ring section forms an intermediate layer between the contact element (which is arranged radially inside the insulating element) and the sensor element (which is arranged radially outside the insulating element), so that the insulating element forms an electrically insulating intermediate layer between the contact element and the sensor element.

In one development, a line conductor is connected to the contact body at an end of the contact element that is remote from the contact lamellae. A current can be conducted to the contact element via such a line conductor.

The contact element assembly can, for example, be a component of a plug connector part. When the plug connector part is being plugged into an associated mating plug connector part, the contact element of the contact element assembly comes into electrically contacting connection with a mating contact element of the mating plug connector part, so that an electrical connection of electrical lines can be established via the plug connector created by the plug connector part and the mating plug connector part.

The plug connector part can be, for example, a part of a charging system for charging an electric vehicle. For example, the plug connector part can realize a charging plug that is arranged on a charging cable and can be connected, for example, to a charging socket on the side of an electric vehicle.

In this case, the evaluation device can be part of the plug connector part or even a higher-level assembly, for example a charging station or a vehicle.

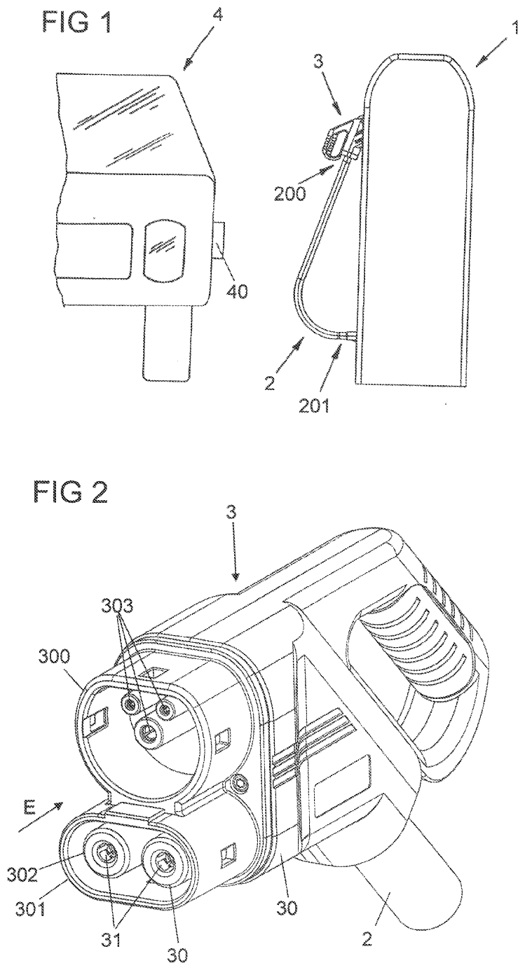

FIG. 1 shows a charging station 1 that serves to charge an electrically powered vehicle 4, also referred to as an electric vehicle. The charging station 1 is designed to provide a charging current in the form of an alternating current or a direct current and has a cable 2 that is connected at one end 201 to the charging station 1 and at another end 200 to a mating plug connector part 3 in the form of a charging plug.

As can be seen from the views according to FIG. 2, the plug-in connector part 3 in the form of the charging plug has plug-in sections 300, 301 on a housing 30, with which the plug-in connector part 3 can be brought into plugged-in engagement with an associated mating plug-in connector part 40 in the form of a charging socket on the vehicle 4. In this way, the charging station 1 can be electrically connected to the vehicle 4 in order to transmit charging currents from the charging station 1 to the vehicle 4.

In order to enable a rapid charging of the electric vehicle 4, for example within the framework of a so-called rapid charging process, the transmitted charging currents have a high current intensity, for example greater than 300 A, possibly even of the order of 500 A or more. As a result of such high charging currents, thermal losses occur at the cable 2 and also at the plug connector part 3 and also at the mating plug connector part 40, which can lead to the heating of the cable 2, of the plug connector part 3 and of the mating plug connector part 40.

The plug connector part 3 has contact elements 31 that are each connected to an associated load line for transmitting charging currents in the form of a direct current and, when the plug connector part 3 is plugged into the mating plug connector part 40, come into engagement with associated mating contact elements in an electrically contacting manner.

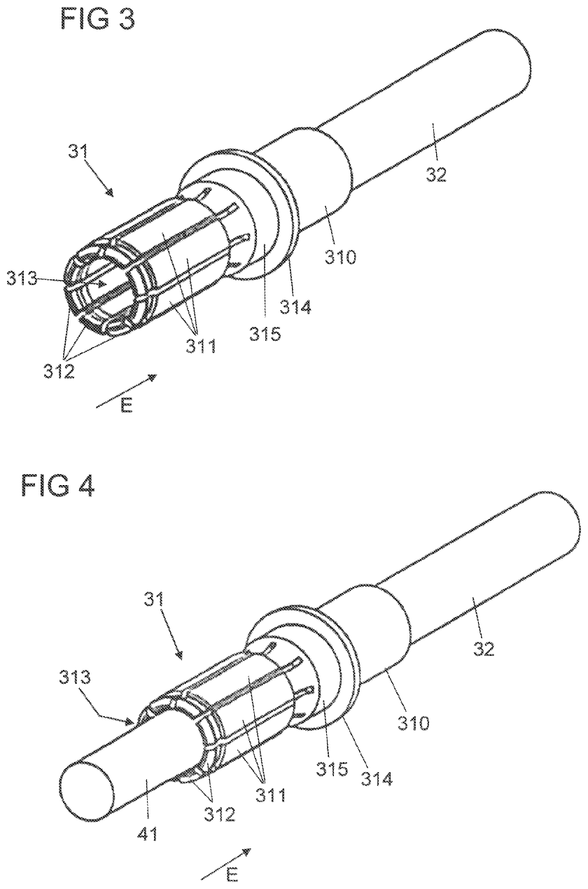

In the case of the plug connector part 3 in the form of the charging plug shown in FIG. 2, contact elements 31 are arranged on the lower plug section 301 in FIG. 3 and realize load contacts for transmitting the charging current. The contact elements 31 are designed in the manner of contact sockets and are arranged within plug domes 302 inside the plug-in section 301. Further contact elements 303 on the upper plug-in section 300 in FIG. 2 serve to transmit control signals.

FIGS. 3 and 4 show an exemplary embodiment of a contact element 31, which is designed as a contact socket and is connected to a load line 32.

The contact element 31 has a contact body 310 with a cylindrical basic shape on which is formed a shaft section 315 and a collar 314 projecting radially relative to the shaft section 315. Contact lamellae 311 project from the shaft section 315 and are separated from one another by slots and are arranged in line with one another along a circumferential direction around a plug-in direction E along which the contact element 31 can be connected to an associated mating contact element 41.

The contact lamellae 311 together form a plug opening 313 around which the contact lamellae 311 are grouped. In this case, the contact lamellae 311 point away from the shaft section 315 with their tips 312.

For the plug-in connection, a mating contact element 41, as shown in FIG. 4, can be plugged into the plug opening 313 along the plugging direction E by the mating contact element 41 running on the inner side of the contact lamellae 311 in the region of the tips 312 and being pushed between the contact lamellae 311. The mating contact element 41 in this case comes into electrically contacting contact with the contact lamellae 311, so that an electrical connection is established between the contact element 31 and the mating contact element 41.

The contact lamellae 311 are elastically movable at the contact body 310. The contact lamellae 311 are formed integrally and in one piece with the contact body 310, but can be deflected (slightly) at the contact body 310 and lie, when the mating contact element 41 is plugged into the plug opening 313, with elastic contact force on the rigidly formed mating contact element 41, so that a low-resistance transition between the contact element 31 and the mating contact element 41 is created.

The heating at a plug connector part 3 in the form of a charging plug, as shown in FIG. 2, can occur in particular in the region of the contact elements 31, wherein the heating substantially depends on the transfer resistance between the contact elements 31 and the associated mating contact elements and thus on the ohmic power loss occurring at the contact elements 31.

Thereby, the transfer resistance between the contact element 31 and an associated mating contact element 41 depends in particular on the operability of the contact lamellae 311 and on a contact force existing between the contact lamellae 311 and the mating contact element 41. If wear or damage occurs on one or more of the contact lamellae 311, as a result of which the contact force between the contact lamellae 311 and the mating contact element 41 is reduced, or if for the production of the contact even one or more contact lamellae 311 fail due to an exceptional deformation, for example a buckling or a break, the transfer resistance between the contact element 31 and the mating contact element 41 can be increased, which goes hand in hand with an increase in the power loss and thus with a greater heating.

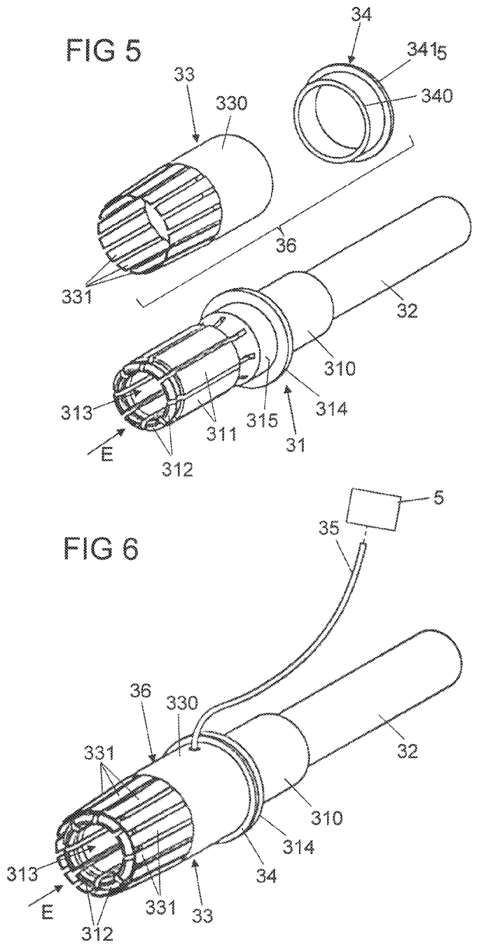

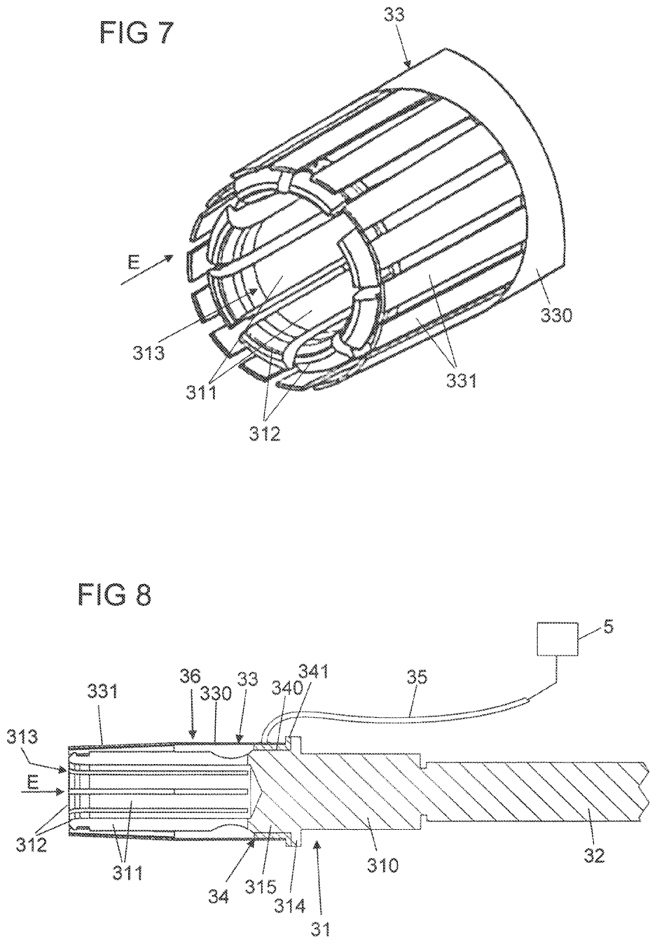

In an exemplary embodiment illustrated in FIGS. 5 to 10A, 10B, a sensor device 36 is arranged on the contact element 31, said sensor device having a sensor element 33 to which a connecting line 35 and, via the connecting line 35, an evaluation device 5 are connected.

In the exemplary embodiment shown, the sensor element 33 has an element body 330 in the form of a cylindrical sleeve, which is arranged circumferentially outside the contact lamellae 311 of the contact element 31. The element body 330 is circumferentially closed and thus surrounds the contact lamellae 311 circumferentially.

Test fingers 331, which are arranged in line with one another circumferentially around the plug-in direction E and separated from one another via axially extending slots, extend axially from the element body 330. The test fingers 331 starting from the element body 330 extend in the direction of the tips 312 of the contact lamellae 311 and come to rest on the outside of the contact lamellae 311, wherein the test fingers 311 in a normal, operational state are at a distance from the contact lamellae 331.

The test fingers 331 are elastically deflectable at the element body 330. The test fingers 331 should in particular not provide a support for the contact lamellae 311 radially outwards and are thus elastically flexible and deformable under the action of the contact lamellae 311 in the event of an exceptional deformation on one or more contact lamellae 311.

The element body 330 is arranged on an insulating element 34 that is arranged with a ring section 340 on the shaft section 315 of the contact element 31 and with a flange section 341 that projects radially relative to the ring section 340 faces the collar 314 of the contact element 31. The insulating element 34 occupies an intermediate layer between the contact element 31 and the sensor element 33, so that the sensor element 33 is in electrical contact with the contact element 31 via the insulating element 34.

The sensor element 33 is firmly connected to the contact element 31 via the insulating element 34.

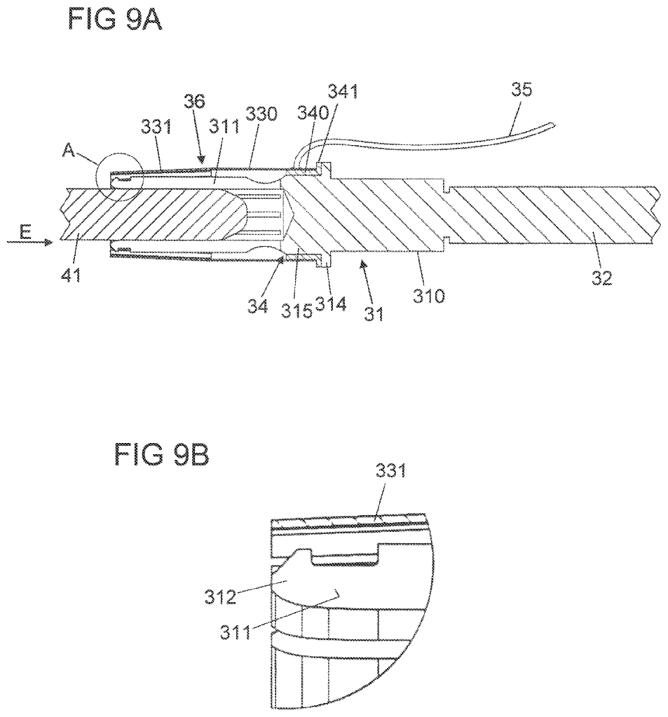

In an operational state, shown in FIG. 8 and when plugged into an associated mating contact element 41 in FIGS. 9A and 9B, the test fingers 331 are at a distance from the contact lamellae 311. The sensor element 33 is thus electrically separated from the contact element 31 and is in particular not at the same potential as the contact element 31.

When the mating contact element 41 in the form of the contact pin is in plugged-in connection with the contact element 31 in the form of the contact sockets, the contact lamellae 311 are (slightly) deflected, widening the plug opening 313 and thus causing an elastic preload on the contact lamellae 311. In the case of an intended plugging-in process in the case of contact lamellae 311 deflected in the intended manner, the contact lamellae 311 here do not come into contact with the test fingers 331 or the element body 330, so that the sensor element 33 remains electrically separated from the contact element 31.

In particular, in the intended state, the contact lamellae 311 do not leave an imaginary envelope circle extending around the contact lamellae 311, outside of which the test fingers 331 are located.

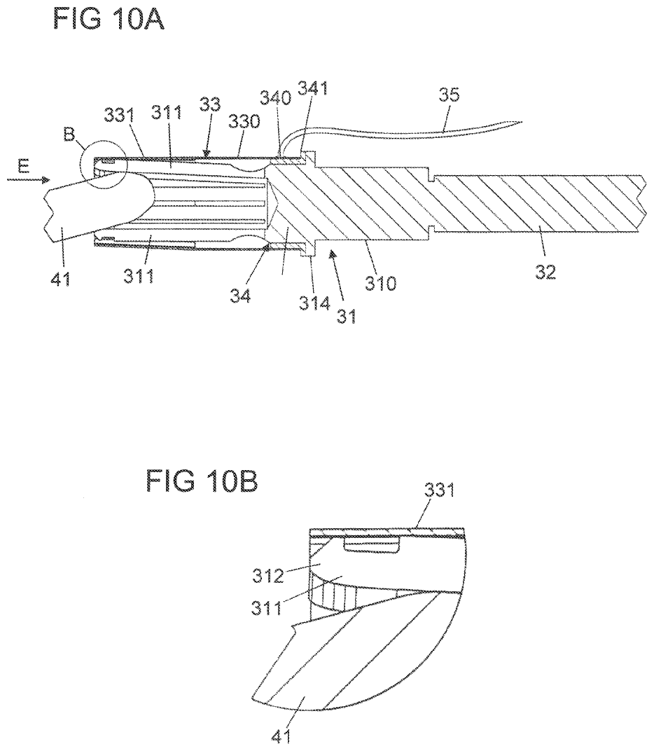

If an incorrect plugging-in process occurs, as shown in FIGS. 10A and 10B, or there is wear or breakage at one or more of the contact lamellae 311, excessive, exceptional deformation can occur on one or more contact lamellae 311, as can be seen from FIGS. 10A and 10B. As a result of such an exceptional deformation, one or more contact lamellae 311 come into electrical contact with the test fingers 331 of the sensor element 33, so that the sensor element 33 is brought to the electrical potential of the contact element 31. Such a change in potential can be detected via the evaluation device 5, which is connected via the connection line 35 to the sensor element 33, so that it can be evaluated whether an exceptional deformation on the contact lamellae 311 of the contact element 31 has occurred.

An exceptional deformation on the contact lamellae 311 can be temporary or permanent. In the case of an incorrect plugging-in process, as shown in FIGS. 10A and 10B, deformation on the contact lamellae 311 may be only temporary, for example. In the event of wear or breakage, however, deformation can be permanent and plastic.

In both cases, such an exceptional deformation can be evaluated and displayed via the evaluation device 5, in order to initiate a suitable countermeasure, for example to modify or interrupt a current transmission process by reducing the current intensity.

The idea underlying the invention is not limited to the exemplary embodiments described above but can in principle also be realized in a completely different manner.

A connector part of the type described here can advantageously be used in a charging system for charging an electric vehicle. However, such a contact element assembly can also be used in another application, in particular where large currents are to be transmitted.

A sensor element can be designed to be rigid or, as in the illustrated exemplary embodiment, elastic in sections. Such a sensor element can have a sleeve shape, but can also be shaped differently and in particular deviate from a cylindrical shape.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

List of reference signs

| | |
|---|---|
| 1 | Charging station |
| 2 | Charging cable |
| 200, 201 | End |
| 3 | Charging plug |
| 30 | Housing |
| 300, 301 | Plug-in section |
| 302 | Plug dome |
| 303 | Signal contacts |
| 31 | Contact element (contact socket) |
| 310 | Contact body |
| 311 | Contact lamella |
| 312 | Tip |
| 313 | Plug opening |
| 314 | Collar |
| 315 | Shaft section |
| 32 | Core |
| 33 | Sensor element (sensor sleeve) |
| 330 | Element body |
| 331 | Test finger |
| 34 | Insulating element |
| 340 | Ring section |
| 341 | Flange section |
| 35 | Sensor line |
| 36 | Sensor device |
| 4 | Vehicle |
| 40 | Mating plug connector part |
| 41 | Mating contact element (contact pin) |
| 5 | Evaluation device |
| E | Plug-in direction |

1. A contact element assembly for a plug connector part connectable to a mating plug connector part, comprising:
a contact element that has a body and a plurality of contact lamellae that are elastically movable at the contact body and that together form a plug opening and are configured to be brought into contact with a mating contact element of the mating plug connector part that is pluggable into the plug opening in an electrically contacting manner; and
a sensor device that has a sensor element that is arranged in relation to the contact lamellae such that in an operational state of the contact lamellae the sensor element is not in electrical contact with the contact lamellae, but is configured to come into electrical contact with the at least one of the contact lamellae upon an exceptional deformation on at least one of the contact lamellae,
wherein the sensor element is connected to an evaluation device configured to evaluate a sensor signal obtained depending on a contact of the at least one contact lamellae with the sensor element.

2. The contact element assembly of claim 1, wherein the sensor is arranged outside the plug opening.

3. The contact element assembly according to claim 1, wherein the sensor element comprises a cylindrical element body.

4. The contact element assembly of claim 3, wherein the cylindrical element body extends circumferentially around the contact element.

5. The contact element assembly of claim 3, wherein the cylindrical element body is circumferentially closed.

6. The contact element assembly according to claim 3, wherein the sensor element has at least one test finger arranged on the element body, the test finger being configured to come into electrical contact with the at least one of the contact lamellae upon an exceptional deformation on at least one of the contact lamellae.

7. The contact element assembly of claim 6, wherein the at least one test finger extends axially from the cylindrical element body towards tips of the contact lamellae that lie away from the contact body.

8. The contact element assembly of claim 6, wherein the at least one test finger is elastically movable at the element body.

9. The contact element assembly according to claim 1, further comprising:
an insulating element that is arranged on the contact body,
wherein the sensor element is arranged on the insulating element and is electrically insulated from the contact element via the insulating element.

10. The contact element assembly of claim 9, wherein the insulating element has a ring section that circumferentially surrounds the contact element and is arranged between the contact element and the sensor element.

11. The contact element assembly claim 1, further comprising:
a line conductor that is connected to the contact body at an end of the contact element that is remote from the contact lamellae.

12. A plug connector part, comprising:
the contact element assembly of claim 1.

13. The plug connector part of claim 12, wherein the plug connector part comprises a component of a charging system for charging an electric vehicle.
